(19) United States
(12) Patent Application Publication
(10) Pub. No.: US 2018/0082599 A1
(43) Pub. Date: Mar. 22, 2018

(54) Collision Warning Assembly

(71) Applicant: Trung Nguyen, Johns Creek, GA (US)

(72) Inventor: Trung Nguyen, Johns Creek, GA (US)

(21) Appl. No.: 15/271,904

(22) Filed: Sep. 21, 2016

(51) Int. Cl. G08G 9/02; G08B 21/02

(52) U.S. Cl. CPC G08G 9/02; G08B 21/02

(57) ABSTRACT

A collision warning assembly for collision avoidance includes a power module, a control module and a plurality of detector-alarm devices. The control module and the detector-alarm devices are operationally coupled to the power module. The detector-alarm devices are operationally coupled to the control module. The detector-alarm devices are configured for placement along paths to sites of potential collision, such as opposing sides of a doorway and along intersecting hallways. The control module is positioned to process motion signals received from the plurality of detector-alarm devices. Receipt by the control module of motion signals from more than one the detector-alarm device will motivate the control module to selectively actuate the plurality of indicators, such that a user is warned of a potential collision.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to collision warning assemblies and more particularly pertains to a new collision warning assembly for collision avoidance.

### BRIEF SUMMARY OF THE INVENTION

An embodiment of the disclosure meets the needs presented above by generally comprising a power module, a control module and a plurality of detector-alarm devices. The control module and the detector-alarm devices are operationally coupled to the power module. The detector-alarm devices are operationally coupled to the control module. The detector-alarm devices are configured for placement along paths to sites of potential collision, such as opposing sides of a doorway and along intersecting hallways. The control module is positioned to process motion signals received from the plurality of detector-alarm devices. Receipt by the control module of motion signals from more than one the detector-alarm device will motivate the control module to selectively actuate the plurality of indicators, such that a user is warned of a potential collision.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a collision warning assembly according to an embodiment of the disclosure.

FIG. 2 is an in-use view of an embodiment of the disclosure.

FIG. 3 is a block diagram of an embodiment of the disclosure.

### DETAILED DESCRIPTION OF THE INVENTION

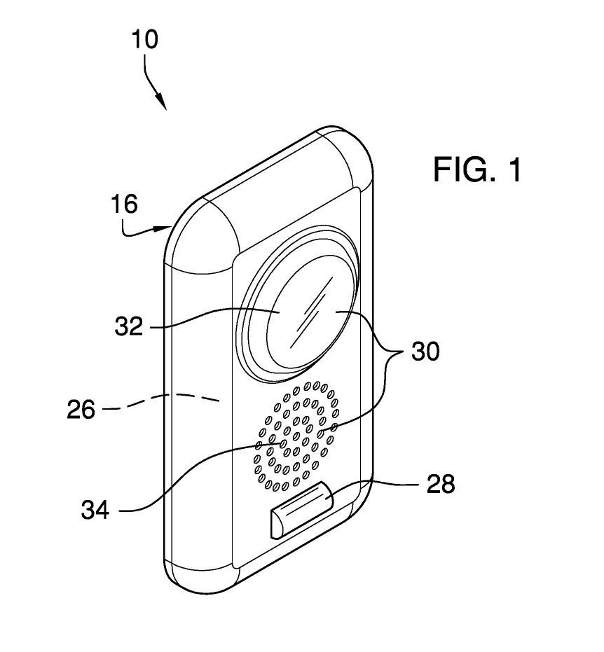

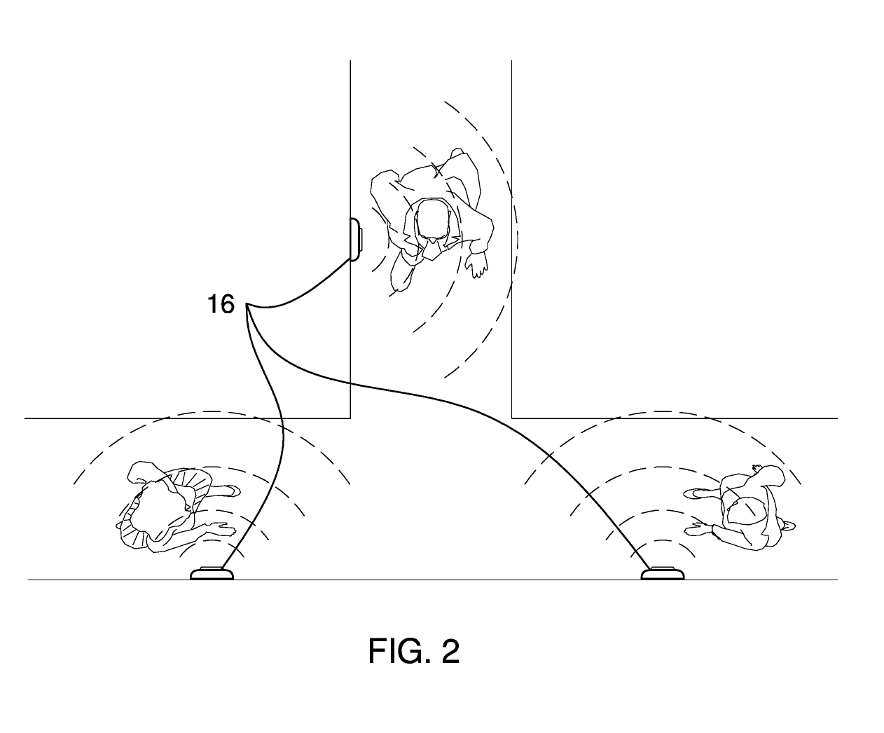

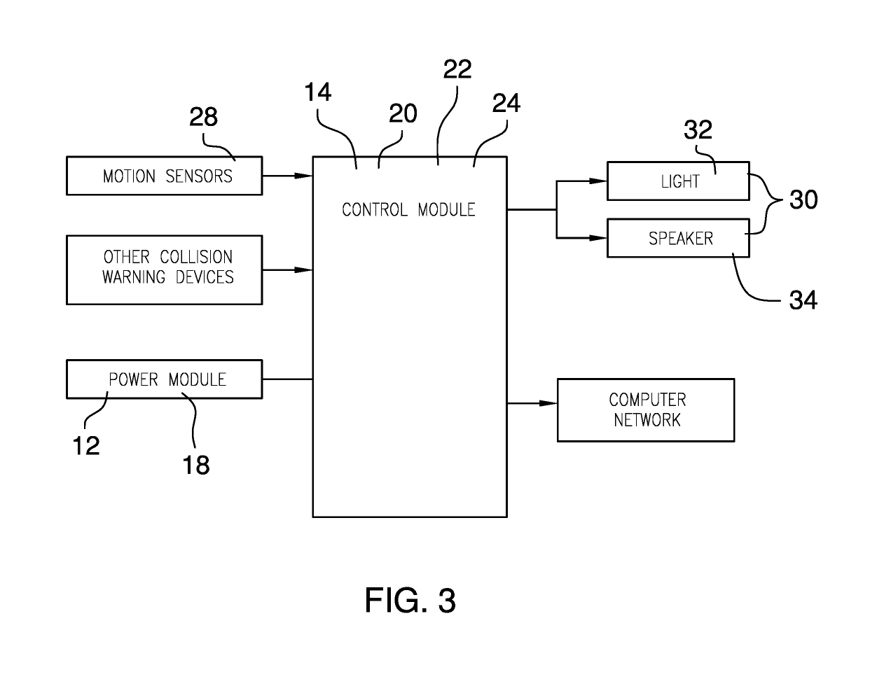

With reference now to the drawings, and in particular to FIGS. 1 through 3 thereof, a new collision warning assembly embodying the principles and concepts of an embodiment of the disclosure and generally designated by the reference numeral 10 will be described.

As best illustrated in FIGS. 1 through 3, the collision warning assembly 10 generally comprises a power module 12, a control module 14 and a plurality of detector-alarm devices 16. The control module 14 and the detector-alarm devices 16 are operationally coupled to the power module 12. The detector-alarm devices 16 are operationally coupled to the control module 14. In one embodiment, the power module 12 comprises at least one battery 18.

In one embodiment, the control module 14 comprises a microcontroller 20. In another embodiment, the control module 14 comprises a programmable logic controller 22. In yet another embodiment, the control module 14 is configured to receive a collision signal from at least one collision warning device in addition to the detector-alarm devices 16. As such, additional collision warning devices are couplable to the control module 14. In still yet another embodiment, the control module 14 comprises a first communicator 24. In still yet another embodiment, the first communicator 24 is wireless. In still yet another embodiment, the control module 14 is configured to couple to a computer network, such that a collision warning is transmittable over the computer network.

The detector-alarm devices 16 are configured to place along paths to sites of potential collision, such as opposing sides of a doorway and along intersecting hallways. In one embodiment, each detector-alarm device 16 is hard-wired to the control module 14. In another embodiment, the detector-alarm device 16 comprises a second communicator 26 that is operationally coupled to the first communicator 24. In yet another embodiment, the second communicator 26 is wireless.

Each detector-alarm device 16 comprises a motion sensor 28 and a plurality of indicators 30. The indicators 30 are configured to alert users to a potential collision. In one embodiment, the plurality of indicators 30 comprises a light 32. The light 32 is configured to emit a visible warning of the potential collision to a user. In another embodiment, the plurality of indicators 30 comprises a speaker 34. The speaker 34 is configured to emit an audible warning of the potential collision to the user.

The present invention anticipates the assembly 10 comprising a plurality of solar panels that is operationally coupled to the power module 12. The present invention also anticipates the assembly 10 comprising a wind-powered generator that is operationally coupled to the power module 12.

The present invention anticipates the control module 14 comprising analog-to-digital converter and digital-to-analog converters. The control module 14 would be enabled to receive analog signals and convert the analog signals to digital signals for processing. Additionally, the control module 14 would be enabled to convert digital output to analog signals for transmission.

In use the second communicator 26 is positioned to relay a motion signal from the motion sensor 28 to the first communicator 24. The control module 14 is positioned to process the motion signal received by the first communicator 24. Receipt by the control module 14 of motion signals from more than one detector-alarm device 16 will motivate the control module 14 to motivate the second communicator 26 to relay a warning signal to the first communicator 24. The plurality of indicators 30 is selectively actuated such that the user is warned of the potential collision.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A collision warning assembly comprising:
a power module, said power module comprising one of a wind powered generator and a plurality of solar panels;
a control module, said control module being operationally coupled to said power module;
a plurality of detector-alarm devices operationally coupled to said power module and said control module, said detector-alarm devices being configured for placement along paths to sites of potential collision; and
wherein said control module is positioned to process motion signals received from said plurality of detector-alarm devices, wherein receipt by said control module of motion signals from more than one said detector-alarm device will motivate said control module to selectively actuate said plurality of indicators such that a user is warned of a potential collision.

2. The assembly of claim 1, further including said power module comprising at least one battery.

3. The assembly of claim 1, further including said control module comprising a microcontroller.

4. The assembly of claim 1, further including said control module comprising a programmable logic controller.

5. The assembly of claim 1, further including said control module being configured for receiving a collision signal from at least one collision warning device, such that additional collision warning devices are couplable to said control module.

6. The assembly of claim 1, further including said control module comprising a first communicator.

7. The assembly of claim 6, further including said first communicator being wireless.

8. The assembly of claim 1, further including each said detector-alarm device being hard-wired to said control module.

9. The assembly of claim 6, further including each said detector-alarm device comprising:
a second communicator operationally coupled to said first communicator;
a motion sensor;
a plurality of indicators configured to alert users to a potential collision; and
wherein said second communicator is positioned to relay a motion signal from said motion sensor to said first communicator, wherein said control module is positioned to process the motion signal received by said first communicator, wherein receipt by said control module of motion signals from more than one said detector-alarm device will motivate said control module to motivate said second communicator to relay a warning signal to said first communicator, wherein said plurality of indicators are selectively actuated such that the user is warned of the potential collision.

10. The assembly of claim 9, further including said plurality of indicators comprising a light, wherein said light is configured to emit a visible warning of the potential collision to a user.

11. The assembly of claim 9, further including said plurality of indicators comprising a speaker wherein said speaker is configured to emit an audible warning of the potential collision to the user.

12. The assembly of claim 1, further including said control module being configured for coupling to a computer network.

13. The assembly of claim 9, further including said first communicator and said second communicator being wireless.

14. A collision warning assembly comprising:
a power module, said power module comprising at least one battery, said power module comprising one of a wind powered generator and a plurality of solar panels;
a control module, said control module being operationally coupled to said power module, said control module comprising a microcontroller, said control module comprising a programmable logic controller, said control module being configured for receiving a collision signal from at least one collision warning device, such that additional collision warning devices are couplable to said control module, said control module comprising a first communicator, said first communicator being wireless, said control module being configured for coupling to a computer network;
a plurality of detector-alarm devices operationally coupled to said power module and said control module, said detector-alarm devices being configured for placement along paths to sites of potential collision, each said detector-alarm device being hard-wired to said control module, each said detector-alarm device comprising:
a second communicator operationally coupled to said first communicator, said second communicator being wireless,
a motion sensor, and
a plurality of indicators configured to alert users to a potential collision, said plurality of indicators comprising a light, wherein said light is configured to emit a visible warning of the potential collision to a user, said plurality of indicators comprising a speaker wherein said speaker is configured to emit an audible warning of the potential collision to the user; and
wherein said second communicator is positioned to relay a motion signal from said motion sensor to said first communicator, wherein said control module is positioned to process the motion signal received by said first communicator, wherein receipt by said control module of motion signals from more than one said detector-alarm device will motivate said control module to motivate said second communicator to relay a warning signal to said first communicator, wherein said plurality of indicators are selectively actuated such that the user is warned of the potential collision.
